(19) United States
(12) Patent Application Publication
(10) Pub. No.: US 2016/0269415 A1
(43) Pub. Date: Sep. 15, 2016

(54) TRANSACTION AUTHORIZATION USING A VOCALIZED CHALLENGE

(71) Applicant: International Business Machines Corporation, Armonk, NY (US)

(72) Inventors: Harold D. Dykeman, Rueschlikon (CH); Oliver Krueger, Hannover (DE); Diego A. Ortiz-Yepes, Rueschlikon (CH)

(21) Appl. No.: 14/800,993

(22) Filed: Jul. 16, 2015

(30) Foreign Application Priority Data
Oct. 24, 2014 (GB) 1418966.6

(51) Int. Cl. H04L 29/06

(52) U.S. Cl. CPC H04L 63/102; H04L 63/126; H04L 2463/102

(57) ABSTRACT

A method of transaction authorization, includes, at a server: receiving, from a computerized transaction system, transaction request data responsive to a user having initiated a transaction via the transaction system; instructing to generate a single use, one-time challenge, vocalized by voice synthesis and call a computerized electronic device of the user, using an endpoint identifier linked to the user, the latter enrolled at the server, to vocally communicate the vocalized challenge to the user; and communicating with the transaction system to validate response data sent by the user, in response to the vocalized challenge, to one or both of the server and the transaction system for validation, to authorize the transaction.

### FOREIGN PRIORITY

This application claims priority to Great Britain Patent Application No. 1418966.6, filed Oct. 24, 2014, and all the benefits accruing therefrom under 35 U.S.C. §119, the contents of which in its entirety are herein incorporated by reference.

### BACKGROUND

The invention relates in general to the field of methods of transaction authorization. In particular, it is directed to methods using challenges such as a mobile transaction authentication number.

The use of mobile Transaction Authentication Numbers (mTANs) has become widespread for the authorization of online transactions. Typically a user (a person) will initiate a transaction (examples include logging into a system, a banking transaction, an online purchase, etc.) and before the transaction is executed a TAN is sent to the user's mobile phone. An mTAN is usually communicated through text messages to a mobile phone of a user. Typically, the user enters the mTAN in a PC application in order to complete the transaction.

An enrollment system is required to link the user to a particular mobile phone number. This can be done in a more or less secure fashion. A relatively secure solution is the following. For example, to enable mTANs for submitting tax returns, a government system mails an authorization code to the user's registered postal address, which enables the user to enter his/her mobile phone number online. In less secure solutions, mTAN enablement is linked to an e-mail account provided by the user. The authorization code is then sent to the e-mail address of this account. Such a process does not verify the identity of the user but rather establishes a consistent mechanism for the user and back-end system to communicate, and thus provides some assurance that the user is always the same person.

The mTAN-based process offers security since the mobile phone and SMS communication is completely separate from the user's PC and the online application. Along with an mTAN, details of the transaction can be sent to the phone and verified by the user. By entering the mTAN in the PC application the user is verifying that the transaction details are correct (e.g., not manipulated by malware) and this serves as a confirmation to the back end system that the correct user has requested the transaction since only that person has access to the mobile phone and the SMS that was sent.

However, such a process cannot be extended to mobile transactions. Indeed, if a transaction is triggered by an application running on a mobile phone (typically a smartphone), the mTAN process cannot be implemented using that mobile phone, and at least not with the same level of assurance. Since both the application and the SMS are accessed by the user on the same physical phone, malware running on that phone could manipulate transactions in a way that this is not visible to the user, e.g., by manipulating both the application and the SMS.

It can be realized that a fundamental problem is that: by moving the transaction to a mobile phone, the end points of both channels are the same (i.e., the mobile phone itself), which can be surreptitiously manipulated by an attacker without the user's awareness. There is, therefore, a need for a solution allowing mobile transactions to be executed in a secure manner.

### SUMMARY

In one aspect, a method of transaction authorization, includes, at a server: receiving, from a computerized transaction system, transaction request data responsive to a user having initiated a transaction via the transaction system; instructing to generate a single use, one-time challenge, vocalized by voice synthesis and call a computerized electronic device of the user, using an endpoint identifier linked to the user, the latter enrolled at the server, to vocally communicate the vocalized challenge to the user; and communicating with the transaction system to validate response data sent by the user, in response to the vocalized challenge, to one or both of the server and the transaction system for validation, to authorize the transaction.

In another aspect, an authorization server includes a processing device configured to: receive, from a computerized transaction system, transaction request data responsive to a user having initiated a transaction via the transaction system; instruct to generate a single use, one-time challenge, vocalized by voice synthesis and call a computerized electronic device of the user, using an endpoint identifier linked to the user, the latter enrolled at the server, to vocally communicate the vocalized challenge to the user; and communicate with the transaction system to validate response data sent by the user, in response to the vocalized challenge, to one or both of the server and the transaction system for validation, to authorize the transaction.

In another aspect, a nontransitory, computer readable storage medium has computer readable instruction stored thereon that, when executed by a computer, implement a method of transaction authorization, the method including receiving, at a server, from a computerized transaction system, transaction request data responsive to a user having initiated a transaction via the transaction system; instructing to generate a single use, one-time challenge, vocalized by voice synthesis and call a computerized electronic device of the user, using an endpoint identifier linked to the user, the latter enrolled at the server, to vocally communicate the vocalized challenge to the user; and communicating with the transaction system to validate response data sent by the user, in response to the vocalized challenge, to one or both of the server and the transaction system for validation, to authorize the transaction.

### BRIEF DESCRIPTION OF THE DRAWINGS

FIG. 1 is a flowchart illustrating high-level steps of a transaction authorization methods, according to embodiments of the invention; and

FIG. 2A illustrates more particularly a challenge being vocally communicated to a user;

FIG. 2B illustrates the user responding to the vocalized challenge by sending a response electronically to a transaction system, as in embodiments.

### DETAILED DESCRIPTION

According to a first aspect, the present invention is embodied as a method of transaction authorization, comprising, at a server: receiving, from a computerized transaction system, transaction request data responsive to a user having initiated a transaction via the transaction system; instructing to generate a single use, one-time challenge, vocalized by voice synthesis and call a computerized electronic device of the user, using an endpoint identifier linked to the user, the latter enrolled at the server, to vocally communicate the vocalized challenge to the user; and communicating with the transaction system to validate response data sent by the user, in response to the vocalized challenge, to the server and/or the transaction system for validation, to authorize the transaction.

In embodiments, the method may comprise one or more of the following features: communicating with the transaction system is carried out to validate response data entered by the user via an interface of the computerized electronic device in response to the vocalized challenge and electronically sent by the computerized electronic device to the server and/or the transaction system for validation; communicating with the transaction system is performed to validate response data that were electronically sent by the computerized electronic device to the transaction system; the transaction request data is received after the user has connected, via the computerized electronic device, to the transaction system, to initiate the transaction at the transaction system, the user having logged into the system; the method further comprises: enrolling the user at the authorization server to link the endpoint identifier to the user, wherein enrolling the user is performed prior to receiving the transaction request data from the computerized transaction system, and wherein enrolling the user comprises logging additional data, such as a secret, and the method further comprises communicating either with the user, via the computerized electronic device, or with the transaction system, to validate additional response data provided by the user in response to an additional challenge in respect of the additional data; and the method further comprises authenticating the user to the server to authorize the transaction.

According to a second aspect, the invention is embodied as a method of obtaining a transaction authorization, comprising, at a computerized transaction system: responsive to a user having initiated a transaction via the transaction system, sending transaction request data to the server; responsive to the server having, in response to the transaction request data sent, instructed to: generate a single-use, one-time challenge, vocalized by voice synthesis; and call a computerized electronic device of the user, using an endpoint identifier linked to the user, the latter enrolled at the server, to vocally communicate the vocalized challenge to the user, communicating with the server to validate response data sent by the user in response to the vocalized challenge, to authorize the transaction; and upon validation of the response data by the server, completing the transaction.

In embodiments, completing the transaction comprises prompting the user to complete the transaction by sending data to the computerized electronic device of the user. The method further comprises receiving, at the transaction system, the response data, which have been electronically sent by the computerized electronic device to the transaction system, and wherein communicating with the server to validate the response data is performed upon receiving the electronically sent response data.

In embodiments of the methods according to either aspects, the expected response data comprise, or can be associated with, a sequence of characters matching the sequence of characters vocalized in the challenge. The characters are vocalized one after the other in the vocalized challenge. In embodiments, the computerized device is a mobile phone, such as a smartphone, and the endpoint identifier is a mobile phone number.

According to another aspect, the invention is embodied as a computerized transaction authorization server, comprising a memory storing computerized methods that are executable to implement all the steps of any one of the methods according to the first aspect of the invention.

According to still another aspect, the invention is embodied as a computerized transaction system, comprising a memory storing computerized methods that are executable to implement all the steps of any one of the methods according to the second aspect of the invention.

According to a final aspect, the invention is embodied as a computer-program product, comprising computer program code means to implement all the steps of any one of the above methods.

Devices, systems and methods embodying the present invention will now be described, by way of non-limiting examples, and in reference to the accompanying drawings.

The present inventors have devised a solution to the problem outlined above, which solution allows transactions to be securely executed by a user, from a mobile phone or any suitable computerized device (handheld devices or not). Building on this solution, embodiments have been explored, which may use different types of channels between: (i) a user 1 (having a computerized device 10, 10a or 10b); (ii) a transaction system 20, enabling users to execute transactions and (iii), an authorization server 30, to authorize such transactions. All these embodiments have in common that a challenge is vocalized and vocally communicated to the user 1 by the authorization server 30. The challenge needs be duly answered, using another type of channel (i.e., electronic), to authorize the transaction that the user has initiated with the transaction system 20. Thus, even if the user receives the call (initiated from the server) on the same device 10, 10a, 10b that is used to execute the transaction, two independent channels are used, which use distinct technologies. This scheme accordingly restore the same level of security as provided by classical mTAN processes. However, the present scheme provides more flexibility in the choice of the end points, for the user. I.e., the user can for instance initiate and execute the transaction from a same end point, e.g., a smartphone. The user can also choose different channels, i.e., one for initiating the transaction and another one for receiving the challenge. The transaction can then be completed using either channel, or even a third one. All these embodiments are now discussed in detail.

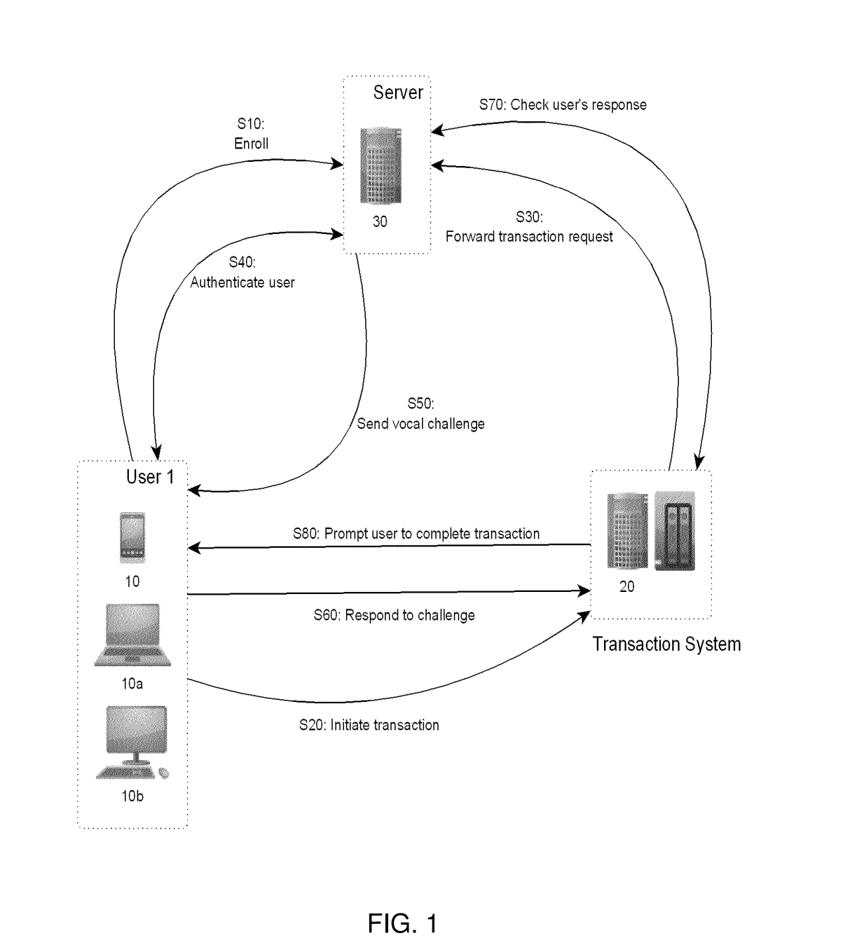

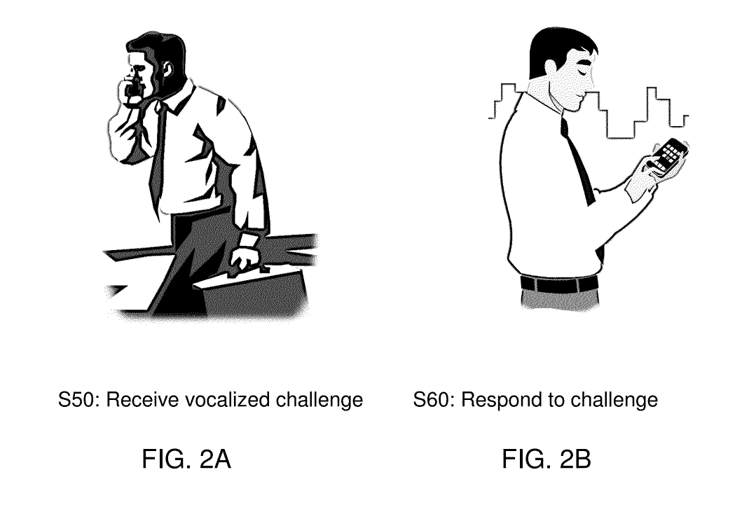

To start with, a first aspect of the invention is described, in reference to both FIGS. 1, 2A and 2B, which concerns methods for authorizing transactions. Such methods are first described from the viewpoint of an authorization server 30.

First, present methods require to enroll a user 1, step S10, in order to link the user to an endpoint identifier, such as a mobile phone number or any identifier to allow any suitable device (running any suitable application, if necessary) of the user to be called. In fact, several endpoint identifiers can be stored on this occasion. The user could also register a fixnet phone number. Such an enrollment procedure is known per se, it can for instance be performed online, by way of a PC or a smartphone, or via a call center. As illustrated in FIG. 1, the enrollment is performed ex-ante. Enrollment may for instance be a pre-requisite to any transaction. Still, enrollment could also be performed on the fly, that is, just after a non-registered user has initiated a transaction, and prior to challenge the user to validate the transaction.

When the user initiates, step S20, a transaction at a computerized transaction system 20, the latter accordingly informs S30 the authorization server. Namely, the server 30 shall receive S30 transaction request data, from the transaction system 20, responsive to the user having initiated the transaction. Any transaction system 20 that allows for online transaction can be contemplated. Note that two typical use of the present scheme are: (i) authorizing a transaction and (ii) authorizing (in the sense or securing) a login. Thus, the concept of “transaction” has, in the context of this invention, a broad meaning. Not only this concept includes an instance of buying or selling something (or more generally of conducting business), but it also encompasses exchanges or interactions via computerized devices. Transaction systems as meant in the present context notably include: banks (or more generally any financial transaction system); online shopping systems; electronic tax payment systems, online betting systems, as well as any computerized system, such as social networks, requiring a user to be logged in.

The transaction system 20 is suitably connected to the server 30, to communicate and exchange information with that server. In fact, all the functionalities of the server 30 may typically be integrated within the system 20 itself. In variants, the authorization process is outsourced to an external server 30. In all cases, the system 20 and server 30 are operatively connected, e.g., via any suitable network (typically the Internet or a local area network), to perform the enrollment and validation steps.

Then, if the user is not enrolled yet, the system 20 may prompt the user to enroll at the server 30 (and, if necessary, via the latter). Once the user is enrolled, the server instructs to generate a single use, one-time challenge. In other words, the server 30 takes steps to initiate the generation of the challenge to be communicated to the user 1, step S50. The process, so far, compares to an mTAN (mobile transaction authentication number) process. However, one remarkable difference with mTAN is that, in the present methods, the challenge is vocalized by voice synthesis (using any suitable computerized vocalization solution, which may be part of the server 30 or, still, may be requested by the server to achieve the same). The server may for instance invoke a text-to-speech solution to vocalize an mTAN before passing it to the user.

Next, the server further instructs to call a computerized electronic device of the user 1, using an endpoint identifier that was already stored in respect of this user, during the enrollment. The device called can for instance be a mobile phone 10 (typically a smartphone or a portable digital assistant, etc.), a laptop 10a, a desktop PC 10b, or any device (e.g., together with any suitable application stored thereon, if necessary), which allows calls to be received on this device, to vocally communicate the vocalized challenge to the user. Note that the call may use wireless telephony or any other suitable network, e.g., be IP-based. Although distinct devices can be involved, it is nevertheless more practical to call the same device as used for initiating and completing the transaction. However, the user may be given the opportunity to enroll a distinct device for validation, together with an associated endpoint identifier. Additional steps may, on this occasion, be taken to secure the enrollment, especially if the user enrolls a distinct device for the purpose of validating challenges.

Once the user has received the vocalized challenge, (s)he must duly answer it. This aspect is discussed in detail below. Next, the server 30 shall communicate, step S70, with the transaction system 20, as necessary to validate the response data sent by the user in response to the vocalized challenge. The response data can be sent to the server and/or the transaction system, depending on the preferred design choice. If sent to the system 20, the response can be passed to the server 30 for validation. The response can otherwise be directly sent to the server, which may crosscheck the response with respect to the challenge. Any suitable validation method can be contemplated, as e.g., known from mTAN processes. Upon validation of the response data by the server 30, the transaction is authorized and the user can complete the transaction, step S80.

The above scheme revolves around a vocalized challenge, vocally communicated to the user to validate a transaction. The challenge may for instance be embodied as a vocalized mTAN (or VmTAN for short), as discussed above. Still, other types of challenge can be contemplated, as known in the art, as long as such types of challenge can be vocalized. As touched earlier, since the authorization uses another channel (a call), to communicate the challenge to the user, than the channel used to initiate and/or complete the transaction, it makes it harder for a malicious user/application to tamper with the authorization scheme. One of the channels has been registered for use with this user and the registration process can be chosen to provide any required reliability and security. Having two separated channels, with of the channels including the vocalized challenge, makes an attack significantly more difficult due to the technical coordination that would be required. In particular, the voice channel would be very difficult to intercept, especially on a phone, or more generally any device, which has not been tampered with.

In embodiments, the user is using the same mobile phone, e.g., a smartphone, to initiate the transaction with the transaction system as will be used to receive the challenge from the server. However the above scheme can apply to many other types of transaction, including a transaction initiated on a desktop PC or by calling a call center.

In embodiments, the response data can be entered by the user via an interface of the computerized electronic device 10, 10a, 10b, in response to the received vocalized challenge. Such a solution is simple (a few characters are typically to be entered), secure (the VmTAN is communicated vocally to the user) and allows the response to be entered and then sent using the same device as used to initiate the transaction. For example, if the challenge is a VmTAN, the user then needs to enter an alphanumeric sequence matching the VmTAN to validate the transaction. As another, but less secure, example, the challenge may consist of a simple question (e.g., “what is the first name of your mother”), as previously arranged with the user during the enrollment process). It will be apparent to the skilled person that many other types of challenge/response can be contemplated.

The response can then be electronically sent S60 by the same electronic device as already used to initiate the transaction to the server and/or the transaction system for validation. The response can for instance be sent as a simple SMS. Note, however, that a typical applications, will require the user to enter the response directly in the application, like in prior solutions, including legacy mTAN systems.

In principle, the response could be sent directly to the server for direct validation by the latter (provided it uses another type of channel than used to contact the user in the first place, for security reasons). Preferably though, the response data is electronically sent to the transaction system. Still, it is to be kept in mind that the server 30 could be part of the system 20. Again, the response data is sent electronically S60 by the same electronic device as already used to initiate the transaction. Such a solution is especially advantageous when willing to secure transactions executed from a sole mobile phone (the user does not use any other device in that case), inasmuch as this solution restores an mTAN-like security as was previously achieved using two distinct devices. However, in variants, it is also possible for the user to communicate with the transaction system in a different way, e.g., via a PC or using a call center.

In all of the above variants, the validation/authorization process uses two different channels set between two or three parties (the user and the system/server), to reach the a security level comparable to that provided by usual mTAN processes.

The user needs to be connected to the system 20 to initiate the transaction and the connection shall be initiated with the same device as already enrolled at the server, to enhance the security of the process. The system 20 may even require the user to be properly logged into the system, to be able to initiate the transaction. As illustrated in FIG. 1, this, in practice, results in that the transaction request data is sent by the system 20 (and received by the server 30) after the user has connected S20, via her/his electronic device, to the transaction system, to initiate the transaction at the transaction system.

In embodiments, the enrollment S10 may require the user to log additional personal data, e.g., a secret, a password, etc., which additional data may in turn be used to further challenge the user, in order to further secure the validation process or to authenticate the user. To that aim, the server 30 (or, in variants, the system 20) may communicate S40 with the user (via a device 10, 10a, 10b of the user) or with the system 20, to validate additional response data provided by the user in response to any additional challenge (in respect of the additional data stored).

The user could be challenged at any time during the transaction, to validate it. The server may also require to authenticate S40 the user, e.g., prior to challenging S50 the user with a vocalized challenge. Authentication may also be performed via the system 20, e.g., via the same application as used to execute the transaction. The user may hence be required to be authenticated to the server 30 and/or the transaction system 20, to enable and/or complete the transaction. In variants, the user may also be challenged with respect to the additional data, in addition to the authentication step, e.g., following the authentication and as a separate step, prior to challenging S50 the user with a vocalized challenge.

As described earlier, many types of challenges can be contemplated. However, in order to ease the validation process, the expected response the vocalized challenge may be or correspond to (i.e., be associated with) a sequence of characters (e.g., alphanumeric characters) matching a sequence of characters as vocalized in the communicated challenge, just like in an mTAN process, except that, here, the characters are vocalized. This type of embodiments would only require little modification of the existing validation systems.

To further ease the process for the user, the characters of the challenged are vocalized one after the other in the vocalized challenge.

For example, an mTAN-like challenge may consist of a sequence like “1-2-6-1-0-8-9”, where the characters (here digits) are stated one after the other, to ease understanding by the user. In that respect, the alphanumeric characters may not be totally random but, rather, are selected according to rules favoring oral understanding. Some characters may deliberately be excluded, to avoid ambiguities, e.g., like “m” and “n”. Also, the characters may be randomly selected among a pool of preselected characters, which have been preselected based on their heterophony. Satisfactory results are obtained by using only digits. In other variants, simple words or phrases may be used, which are randomly chosen among a subset of words or phrases preselected based on their heterophony. In this respect, and as noted earlier, the server 30 may for instance invoke a text-to-speech solution to vocalize the challenge before calling the user. In variants, the server may also instruct to aggregate waveforms corresponding to vocalized sounds (e.g., digits, letters and/or words), selected from a repository of such waveforms. The waveforms may else be selected and then read on-the-fly, while calling the user. Other variants can be contemplated.

Next, and according to another aspect, the invention can also be embodied as a computerized transaction system 20, as illustrated in FIG. 1. Embodiments of the invention are now discussed from the viewpoints of the system 20. Basically, at the system 20, after and responsive to the user 1 having initiated S20 the transaction, the system 20 sends S30 the transaction request data to the server. Next, after the user sends the response data in response to the vocalized challenge (and to the transaction system), the system communicate S70 with the server to validate the data sent S60 by the user, to authorize the transaction. Upon validation S70 of the response data by the server, the system then takes steps S80 to complete the transaction, e.g., it may prompt the user to do so or request additional inputs from the user, to proceed for payment, etc. To that aim, the system 20 may send further data to the electronic device 10, 10, 10b of the user. Note that, in typical cases, the verification server will be implemented directly at the system 20. In that case, different components of the system will need to communicate S70 to validate the transaction, before proceeding to complete S80 it. Interestingly, existing transaction systems need little modification to implement embodiments of this invention. They just need to be modified to include the novel improved “server” functionality, as described above, to authorize the transition.

Next, and according to another aspect, the invention can also be embodied as a computerized transaction system 20 or a transaction authorization server 30, properly equipped with memory storing all the necessary computerized, executable methods, to implement steps as described above. The invention can also be embodied as a computer-program product, comprising computer program code means to implement such steps. Details are given in the next section.

The above embodiments have been succinctly described in reference to the accompanying drawings and may accommodate a number of variants. Several combinations of the above features may be contemplated. Examples are given in the next section.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the ““C”” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been described with reference to a limited number of embodiments, variants and the accompanying drawings, it will be understood by those skilled in the art that various changes may be made and equivalents may be substituted without departing from the scope of the present invention. In particular, a feature (device-like or method-like) recited in a given embodiment, variant or shown in a drawing may be combined with or replace another feature in another embodiment, variant or drawing, to obtain a new combination of features (not explicitly recited herein) that nevertheless remains within the scope of the present invention, especially where such a new combination would provide an advantage recited in the present description and, this, notwithstanding the particular technical contexts in which the features constituting this new combination may have been described, e.g., for the mere sake of illustration, and provided that such a new combination makes sense for the one skilled in the art, in view of other elements described in the present application, such as advantages provided by the features described herein. Various combinations of the features described in respect of any of the above embodiments or variants may accordingly be contemplated, that remain within the scope of the appended claims. In addition, many minor modifications may be made to adapt a particular situation to the teachings of the present invention without departing from its scope. Therefore, it is intended that the present invention not be limited to the particular embodiments disclosed, but that the present invention will include all embodiments falling within the scope of the appended claims. In addition, many variants not explicitly touched above can be contemplated. For example, a user may enroll at an authorization server 30 using a given device 10a (e.g., a PC), while using another device (e.g., a smartphone) to execute transactions.

1. A method of transaction authorization, comprising, at a server:
receiving, from a computerized transaction system, transaction request data responsive to a user having initiated a transaction via the transaction system;
instructing to generate a single use, one-time challenge, vocalized by voice synthesis and call a computerized electronic device of the user, using an endpoint identifier linked to the user, the latter enrolled at the server, to vocally communicate the vocalized challenge to the user; and
communicating with the transaction system to validate response data sent by the user, in response to the vocalized challenge, to one or both of the server and the transaction system for validation, to authorize the transaction.

2. The method of claim 1, wherein communicating with the transaction system is carried out to validate response data entered by the user via an interface of the computerized electronic device in response to the vocalized challenge and electronically sent by the computerized electronic device to one or both of the server and the transaction system for validation.

3. The method of claim 2, wherein communicating with the transaction system is performed to validate response data that were electronically sent by the computerized electronic device to the transaction system.

4. The method of claim 1, wherein the transaction request data is received after the user has connected, via the computerized electronic device, to the transaction system, to initiate the transaction at the transaction system, the user having logged into the system.

5. The method of claim 1, further comprising enrolling the user at the authorization server to link the endpoint identifier to the user, wherein enrolling the user is performed prior to receiving the transaction request data from the computerized transaction system, and wherein enrolling the user comprises logging additional data, such as a secret, and the method further comprises communicating either with the user, via the computerized electronic device, or with the transaction system, to validate additional response data provided by the user in response to an additional challenge in respect of the additional data.

6. The method of claim 1, further comprising authenticating the user to the server to authorize the transaction.

7. The method of claim 1, wherein expected response data is associated with a sequence of characters matching a sequence of characters vocalized in the challenge.

8. The method of claim 7, wherein the characters are vocalized one after the other in the vocalized challenge.

9. The method of claim 1, wherein the computerized device is a mobile device and the endpoint identifier is a mobile phone number.

10. A method of obtaining a transaction authorization, comprising, at a computerized transaction system:
responsive to a user having initiated a transaction via the transaction system, sending transaction request data to the server;
responsive to the server having, in response to the transaction request data sent, instructed to:
generate a single-use, one-time challenge, vocalized by voice synthesis; and call a computerized electronic device of the user, using an endpoint identifier linked to the user, the latter enrolled at the server, to vocally communicate the vocalized challenge to the user, communicating with the server to validate response data sent by the user in response to the vocalized challenge, to authorize the transaction; and
upon validation of the response data by the server, completing the transaction.

11. The method of transaction of claim 10, wherein completing the transaction comprises prompting the user to complete the transaction by sending data to the computerized electronic device of the user.

12. The method of transaction of claim 10, wherein the method further comprises receiving, at the transaction system, the response data, which have been electronically sent by the computerized electronic device to the transaction system, and wherein communicating with the server to validate the response data is performed upon receiving the electronically sent response data.

13. An authorization server, comprising:
a processing device configured to:
receive, from a computerized transaction system, transaction request data responsive to a user having initiated a transaction via the transaction system;
instruct to generate a single use, one-time challenge, vocalized by voice synthesis and call a computerized electronic device of the user, using an endpoint identifier linked to the user, the latter enrolled at the server, to vocally communicate the vocalized challenge to the user; and
communicate with the transaction system to validate response data sent by the user, in response to the vocalized challenge, to one or both of the server and the transaction system for validation, to authorize the transaction.

14. The authorization server of claim 13, wherein communicating with the transaction system is carried out to validate response data entered by the user via an interface of the computerized electronic device in response to the vocalized challenge and electronically sent by the computerized electronic device to one or both of the server and the transaction system for validation.

15. The authorization server of claim 14, wherein communicating with the transaction system is performed to validate response data that were electronically sent by the computerized electronic device to the transaction system.

16. The authorization server of claim 13, wherein the transaction request data is received after the user has connected, via the computerized electronic device, to the transaction system, to initiate the transaction at the transaction system, the user having logged into the system.

17. The authorization server of claim 13, wherein the processing device is further configured to enroll the user at the authorization server to link the endpoint identifier to the user, wherein enrolling the user is performed prior to receiving the transaction request data from the computerized transaction system, and wherein enrolling the user comprises logging additional data, such as a secret, and the method further comprises communicating either with the user, via the computerized electronic device, or with the transaction system, to validate additional response data provided by the user in response to an additional challenge in respect of the additional data.

18. The authorization server of claim 13, wherein the processing device is further configured to authenticate the user to the server to authorize the transaction.

19. The authorization server of claim 13, wherein expected response data is associated with, a sequence of characters matching a sequence of characters vocalized in the challenge.

20. A nontransitory, computer readable storage medium having computer readable instruction stored thereon that, when executed by a computer, implement a method of transaction authorization, the method comprising:
receiving, at a server, from a computerized transaction system, transaction request data responsive to a user having initiated a transaction via the transaction system;
instructing to generate a single use, one-time challenge, vocalized by voice synthesis and call a computerized electronic device of the user, using an endpoint identifier linked to the user, the latter enrolled at the server, to vocally communicate the vocalized challenge to the user; and
communicating with the transaction system to validate response data sent by the user, in response to the vocalized challenge, to one or both of the server and the transaction system for validation, to authorize the transaction.
